(19) United States
(12) Patent Application Publication
(10) Pub. No.: US 2005/0198896 A1
(43) Pub. Date: Sep. 15, 2005

(54) Novel vegetal reinforcing agent based on phytohormones for use in the cultivation of plants or agriculture, preferably in the cultivation of fruit or in wine growing

(76) Inventor: Koen Quaghebeur, Sint-Truiden (BE)

Correspondence Address: D Peter Hochberg Company, 6th Floor, 1940 East 6th Street, Cleveland, OH, 44114, US

(21) Appl. No.: 10/514,696

(22) PCT Filed: May 8, 2003
(86) PCT No.: PCT/EP03/04815

§ 371 Date: Nov. 17, 2004

(30) Foreign Application Priority Data
May 17, 2002 (DE) 102 22 021.2
Sep. 7, 2002 (DE) 102 41 611.7

(51) Int. Cl. A01G 7/00

(52) U.S. Cl. 47/58.1 FV

(57) ABSTRACT

New plant strengthening agents based on phytohormones for application in plant husbandry or arable cropping, preferably in fruit or wine growing. The invention relates to the use of a compound selected from the group gibberellin A₄ (GA₄), gibberellin A₇ (GA₇), gibberellin A₃ (GA₃), 1-naphthaleneacetic acid (NAA), N⁶-benzyladenine (BA) and S-abscisic acid (ABA), or of a mixture of at least two compounds selected from said group, as a plant strengthening agent, to formulations containing said active substances, as well as to a process for strengthening higher plants which is characterized in that a phytoactive amount of at least one of said compounds is applied to said higher plants, preferably to the epigeal parts thereof. Application in plant husbandry or arable cropping, preferably in fruit or wine growing, is preferred.

### CROSS REFERENCE TO RELATED APPLICATIONS

This application is a National Stage application of International Application No. PCT/EP03/04815, filed on May 8, 2003, which claims priority of German application numbers 102 41.611.7, filed on Sep. 7, 2002 and 102 22 021.2, filed on May 17, 2002.

### BACKGROUND OF THE INVENTION

1. Field of the Invention

The present invention relates to formulations containing gibberellins, 1-naphthaleneacetic acid (NAA), N⁶-benzyladenine (BA) and/or S-abscisic acid (ABA), to their use as plant strengthening agents, as well as to a method for strengthening higher plants especially for the purpose of increasing quality and yield as well as for achieving protective effects. The method is characterized in that a phytoactive amount of at least one of these compounds is applied to said higher plants, especially to their epigeal parts.

2. Description of the Prior Art

According to the opinion of the EU Commission, plant strengthening agents are not subject to the requirement of being listed in the positive lists of the Annex II, Part 8 of the Regulation (EEC) No. 2092/91. It is therefore possible to apply plant strengthening agents in ecologic farming which are not mentioned in said Regulation in respect of that purpose.

According to § 2 No. 10 of the law on plant protection (German abbreviation: PflSchG), plant strengthening agents are substances which
a. are intended exclusively for increasing the resistance of plants to pests or harmful plants;
b. are intended exclusively for protecting plants against non-parasitical damage; and
c. are intended for application to cut adornment plants, except for cultivation material.

These agents may, for example, be classified as follows:

1. inorganic-based strengthening agents
SiO₂ and silicates (mineral powders, CaCO₃, Al₂O₃, NaHCO₃;
2. organic-based strengthening agents
   compost extracts, algae extracts, plant extracts, preparations and oils thereof;
3. homoeopathic agents
   homoeopathic (potentiated) form of any of the starting substances mentioned under items 1 and 2;
4. microbial-based preparations

The above-described substances have long been known in science, but not their use as plant strengthening agents.

Improved rooting of cuttings and prevented fruit drop have been described for NAA; defoliation, inhibition of flowering and fruit drop have been described for ABA; and the property of causing quick growth has been described for GA3 in Römpp, Chemie Lexikon, Georg Thieme Verlag 1995.

Gibberellins are a group of plant growth substances (phytohormones). Since 1938, when a gibberellin was first isolated from the culture filtrate of the Japanese fungus Gibberella fujikuroi in Japan, more than 70 different gibberellins have become known to date. Their structure goes back to ent-gibberellan, a tetracyclic diterpenoid. The use of gibberellins for plants after bloom was already known to be a quality-enhancing measure.

Likewise, it was already known to use the auxins 1-naphtha-leneacetic acid (NAA) and 1-napthylacetamide (NAD) seven to 10 days after the bloom to thin the flowers.

Cytokinins were named after their property of promoting cell division (cytokinesis). Zeatin, the first natural cytokinin was discovered in unripe maize kernels in 1964. N⁶-benzyladenine (6-benzylaminopurin; BA), which belongs to the synthetic cytokinins, stimulates, amongst others, cytokinesis, promotes the sprouting of lateral buds and delays senescence.

S-abscisic acid (ABA), (S)-5-(1-hydroxy-2,6,6-trimethyl-4-oxo-2-cyclohexenyl)-3-methyl-cis/trans-2,4-pentadienoic acid is a frequently occurring sesquiterpene having the backbone of the ionones and being isolated from potatoes, avocado pears, cabbage, rose leaves, cotton fruit and numerous trees. As a phytohormone having inhibiting action ABA causes defoliation, bloom inhibition and fruit drop and it induces hibernation-like states. It is thus an antagonist of the plant growth substances. The use of ABA in flowering plants and the prolongation of the duration of the bloom of the treated plants have already been described in U.S. Pat. No. 5,173,106.

The function of ABA is to transform environmental influences to biological reactions within the plant.

What is disadvantageous for quality-enhancing use in plant husbandry is the fact that ABA is degraded photolytically. This is prevented by adding suitable UV-filters.

It has now surprisingly been found that certain gibberellins, 1-naphthaleneacetic acid (NAA), N⁶-benzyladenine (BA) and S-abscisic acid (ABA) show surprising effects in various crops such as, for example, grapes, apples and pears which correspond to the features of plant strengthening agents.

When using ABA in accordance with the invention in apples and pears, the surprising effect of quick leaf abortion is observed. This feature means that, in a treated crop a substantially improved aeration is achieved, thereby reducing infestation of the crop with fungal diseases. This makes a further treatment with a fungicide unnecessary.

In cherry crops it is an important problem that if it rains shortly before the harvest the cherries are capable of absorbing large quantities of water in their interior. This frequently causes them to burst so that they can no longer be utilized. Exogenous application of ABA in cherry crops before rainfall reduces the bursting of the variety Hedelfinger, for example, by up to 30%.

By using these substances as plant strengthening agents in ecologic farming, it is possible to achieve effects of great use in various crops.

### SUMMARY OF THE INVENTION

An object of the present invention is the use of a compound, selected from the group gibberellin A₄ (GA₄), gibberellin A₇ (GA₇), gibberellin A₃ (GA₃), 1-naphthaleneacetic acid (NAA), N⁶-benzyladenine (BA) and S-abscisic acid (ABA) or a mixture of at least two substances selected from this group, as a plant strengthening agent.

Another object of the present invention is the use of a mixture of GA₄ and GA₇, or GA₃, NAA, BA or ABA to be applied in plant husbandry or agriculture, such as in fruit or wine growing, and particularly in fruit growing.

### DETAILED DESCRIPTION OF THE PRESENT INVENTION

According to one embodiment of the invention, BA is used in combination with NAA in pomiferous fruit crops, preferably apple crops, with an application dosage of 10 to 200, preferably 50 to 150, especially 80 to 120 g/ha of BA and an application dosage of 1 to 50, preferably 5 to 25, especially 8 to 12 g/ha of NAA, possibly together with a wetting agent. With preference, application takes place in the 8 to 14 mm stage, preferably 10 to 12 mm.

According to a further embodiment of the invention, GA₃ and/or GA_{4/7} is/are used during the blooming period in the cultivation of winery grapes, table grapes or of grapes for special purposes, to enhance quality and as a protective measure against botrytis disease, in an application concentration of 5 to 100, preferably 5 to 50, especially 10 to 20 ppm, based on a quantity of water of 300 to 500, preferably 350 to 450 l/ha.

Furthermore, in accordance with the invention ABA is used for quality enhancement in root vegetables or leafy vegetables or salad plants, preferably in beets or endive, in an application dosage of 0.2 to 100, preferably 0.5 to 50, especially 0.7 to 25 g/ha.

The invention furthermore relates to a process for strengthening higher plants which is characterized in that a phytoactive amount of at least one of the compounds from the group gibberellin A₄ (GA₄), gibberellin A₇ (GA₇), gibberellin A₃ (GA₃), 1-naphthaleneacetic acid (NAA), N⁶-benzyladenine (BA) and S-abscisic acid (ABA) is applied to said higher plants, especially to their epigeal parts, in the form of a suitable formulation.

Finally, the invention relates to formulations, containing at least one compound selected from the group of gibberellin A₄ (GA₄), gibberellin A₇ (GA₇), gibberellin A₃ (GA₃), 1-naphthaleneacetic acid (NAA), N⁶-benzyladenine (BA) and S-abscisic acid (ABA), together with a suitable carrier, additive and/or auxiliary substances, for use as plant strengthening agents, said use taking place after dilution to a concentration suitable for application.

The above-mentioned active agents may be used as tank mixtures, with each active agent being formulated individually and mixed with other formulated active agents in the spray tank of the sprayer only at the time of application, or they can be formulated together, in different ways depending on the given biological and/or chemophysical parameters. Suitable formulations are, for example: wettable powder (WP), emulsifiable concentrates (EC), water-soluble powder (SP), water-soluble concentrates (SL), concentrated emulsions (EW) such as oil-in-water and water-in-oil emulsions, sprayable solutions or emulsions, capsule suspensions (CS), oil-based or water-based dispersions (SC), suspo-emulsions, suspension concentrates, granules (GR) in the form of micro-, spray, coated and adsorption granules, water-soluble granules (SG), water-dispersible granules (WG), microcapsules and active agent-containing tablets.

In principle, these individual types of formulation are known, and they are described, for instance, in: Winnacker-Küchler, “Chemische Technologie” volume 7, C. Hanser Verlag München, 4th edition 1986; Wade van Valkenburg, “Pesticide Formulations”, Marcel Dekker N.Y., 1973; K. Martens, “Spray Drying Handbook”, 3rd edition 1979, G. Goodwin Ltd. London.

The required formulation auxiliary substances such as inert materials, surfactants, solvents and further additives are also known, and are described, for instance, in: Watkins, “Handbook of Insecticide Dust Diluents and Carriers”, 2nd edition, Darland Books, Caldwell N.J.; H.v. Olphen “Instruction to Clay Colloid Chemistry”, 2nd edition, J. Wiley & Sons, N.Y., Marsden “Solvents Guide”, 2nd edition, Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflächenaktive Äthylenoxidaddukte”, Wiss. Verlagsgesell., Stuttgart 1976; Winnacker-Küchler “Chemische Technologie”, volume 7, C. Hanser Verlag München, 4th edition 1986.

Wettable powders are preparations that can be evenly dispersed in water and that in addition to the active substance and apart from a diluent or inert substance also contain wetting agents, e.g. polyoxyethylated alkyl phenols, polyoxyethylated fatty alcohols and fatty amines, fatty alcohol polyglycol ether sulfates, alkane sulfonates or alkylaryl sulfonates and dispersing agents, e.g. sodium lignin sulfonate, sodium salt of 2,2-dinaphthylmethane-6,6′-disulfonic acid, sodium salt of dibutylnaphthalenesulfonic acid, or sodium salt of oleylmethyltauric acid.

Ethoxylated sorbitan esters and siloxanes have proved to be particularly suitable for the application of ABA. By adding these substances directly to the preparation or as a tank mixing partner, the amount of ABA can be reduced and its effects can be increased.

Emulsifiable concentrates are produced by dissolving the active agent in an organic solvent, e.g. butanol, cyclohexanone, dimethylformamide, xylene, or higher-boiling aromatics or hydrocarbons with addition of one or more emulsifiers. Substances that can be used as emulsifiers are, for example: alkylaryl sulfonic acid calcium salts such as Ca-dodecylbenzenesulfonate or non-ionic emulsifiers such as fatty acid polyglycol esters, alkylarylpolyglycol ethers, fatty alcohol polyglycol ethers, propylene oxide-ethylene oxide condensation products (e.g. block polymers), alkyl polyethers, sorbitan fatty acid esters, polyoxyethylene sorbitan fatty acid esters or polyoxyethylene sorbite esters.

Granulates may be produced either by nozzle atomization of the active substance onto adsorptive, granulated inert material or by applying active substance concentrates by means of adhesives, e.g. polyvinyl alcohol, sodium salt of polyacrylic acid, or mineral oils to the surface of carrier substances such as sand, kaolinites or of granulated inert materials. Suitable active agents can also be granulated in the manner usual for the production of fertilizer granulates—if desired in mixture with fertilizers.

Apart therefrom the above-mentioned active agent formulations optionally contain the usual adhesive, wetting, dispersing, emulsifying, penetrating substances and solvents, filling agents or carrier substances.

For application, the formulations, which are present in commercial form, are if required diluted in the usual manner, e.g. by means of water in the case of wettable powders, emulsifiable concentrates, dispersions and water-dispersible granulates.

Application forms are, for example, liquid preparations with a GA₄ and/or GA₇ content of 1 to 500 g/l. Preferred concentrations of GA₄ and/or GA₇ are 2-50 g/l, especially 5-20 g/l.

GA₃ is preferably used in concentrations with 1 to 50%-wt and particularly with 5 to 20%-wt in solid form (tablets or granules), and 10 to 500 g/l and particularly 10 to 200 g/l in liquid form.

The concentration of NAA is 1 to 50%-wt, preferably 2 to 40%-wt, especially 5 to 15%-wt, in solid form (powder or granules), and 10 to 500 g/l, preferably 20 to 400 g/l, especially 50 to 150 g/l, in liquid form. The concentration of NAA is 1 to 50%-wt, preferably 2 to 40%-wt, especially 5 to 15%-wt, in solid form (powder or granules), and 10 to 500 g/l, preferably 20 to 400 g/l, especially 50 to 150 g/l in liquid form.

A further surprising inventive feature of the phytohormonal properties of ABA is the effect of promoting the protein and sugar transport in the plants from the leaves into the root(s).

Just as astonishing is the effect that exogenous application of ABA leads to frost resistance in crops, e.g. pears and apples, of adornment plants and fruit crops which has been observed. Application about 24 hours prior to the frost reduced the number of damaged flowers in chrysanthemums by 48%.

Comparable use in fruit cultivation in spring in the stage of flowering thus reduces crop failure in the culture.

It has furthermore been observed that trees in fruit crops following rain after a prolonged period of dryness burgeon again. This has a negative influence on the quality of the fruit. Application of ABA prevents renewed burgeoning of the plants. This effect has also been observed in potatoes.

If ABA is used in accordance with the invention, about 2 to 3 weeks before harvest, in sugar-beets, the sugar present in the leaves is additionally transported into the body of the beet, which leads to an increase in quality. The same effect is observed in potatoes, red beet and carrots. The increase in sugar content leads to a substantial quality improvement of the harvested produce.

ABA can also be used for quality enhancement in wine growing. If ABA is applied for several weeks prior to harvest, this simulates a draught period in the vine which leads to a reduction of the size of the grapes by up to 10% in conjunction with a comparable increase in sugar content. This leads to a higher density of the wine and thereby to wines with improved storage stability. Analogous effects occur in pears and apples.

In the application of ABA in firs and spruces, which is likewise in accordance with the invention, a reduction of stress-susceptibility can be observed. This is an essential aspect in the harvest of these crops as Christmas trees since the trees keep their needles for much longer than untreated trees.

Comparable effects are observed in various crops when using GA₃ (gibberellinic acid).

The following special effects can be observed when GA₃ is used in accordance with the invention in grapes:

Compared to treatment with ethephon (growth regulator)
no reduction in grape weight is observed;
the mean grape diameter is larger;
the density of the wine and the colour, and thereby the wine quality, are improved.

What is more important, however, is the finding that because of a loosening-up of the grapes (lengthening of the stalks) there is a reduction in infestation with botrytis disease. By contrast to conventional treatment with fungicides this happens purely mechanically/morphologically since the greater length of the stalks prevents mutual pushing away of the grapes, and damage to the grapes is thereby avoided. Such damage results in the occurrence of nest-shaped focuses of rot. When applied in the same way, gibberellin (GA_{4/7}) shows comparable results.

It is well-known that the phytohormonal properties of NAA prevent fruit drop. Furthermore, it has already been known to use BA in nurseries to improve burgeoning in young plants.

Surprisingly, it is observed, however, that when BA and NAA are used simultaneously in apples there are synergistic effects in terms of the thinning of the fruit which are not to be expected on the basis of the aforementioned known properties. This is observed especially when these agents are applied together with a wetting agent.

Substances suitable as wetting agents are, for example, alkali salts, alkaline earth salts or ammonium salts of aromatic sulfonic acids, e.g. lignin-, phenol-, naphthalene- and dibutylnaphthalenesulfonic acid, as well as of fatty acids, alkyl and alkylaryl sulfonates, alkyl, lauryl ether and fatty alcohol sulfates, as well as salts of sulfated hexa-, hepta- and octadecanols and of fatty alcohol glycol ethers, condensation products of sulfonated naphthalene and its derivatives with formaldehyde, condensation products of naphthalene or of the naphthalenesulfonic acids with phenol and formaldehyde, and furthermore polyoxyethyleneoctylphenol ether, ethoxylated isooctyl phenol, octyl phenol or nonyl phenol, alkylphenol polyglycol ether, tributyl phenyl polyglycol ether, alkyl aryl polyether alcohols, isotridecyl alcohol, fatty alcohol ethylene oxide condensates, ethoxylated castor oil, polyoxyethylene alkyl ether or polyoxypropylene, lauryl alcohol polyglycol ether acetate, sorbite ester, lignin-sulfite waste lyes or methyl cellulose.

The use according to the invention yields the best effect when the apples are in the stage of about 10 to 12 mm.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. Use of S-abscisic acid (ABA) in plant husbandry, wherein said ABA has a use selected from the group consisting of:
an agent for quality enhancement in leafy vegetable or salad cultures,
an agent for preventing the bursting of cherries, and
an agent for preventing renewed burgeoning of fruit trees or potato plants caused by rain.

2. Use of S-abscisic acid (ABA) in plant husbandry, wherein said ABA is in the form of a formulation comprising ABA and at least one additional substance selected from the group consisting of a carrier, an additive and at least one auxiliary substance, and wherein said ABA is used as an agent to increase at least one of the sugar content or protein content in roots or to enhance the quality in beet growing.

3. Use according to claim 2, wherein said ABA, in the form of said formulation, is used as an agent to increase at least one of the sugar content or protein content in sugar-beets, potatoes, red beet or carrots.

4. Use according to claim 1, wherein said ABA is used as an agent to increase the quality of endives.

5. Use according to claim 4, wherein said ABA is used in combination with at least one additional compound selected from the group consisting of gibberellin A₄ (GA₄), gibberellin A₇ (GA₇), gibberellin A₃ (GA₃), 1-naphthaleneacetic acid (NAA) and N⁶-benzyladenine (BA).

6. Use according to claim 1, wherein said ABA is used in an application dose of 0.2 to 100 g/ha.

7. Use according to claim 1, wherein said compound(s) is/are used in the form of commonly used formulations containing at least one known formulation auxiliary agent selected from the group consisting of carrier materials, surfactants, solvents and additives.

8. Use according to claim 1, further including applying a phytoactive amount of said compound(s) to said plants, wherein said plants have epigeal parts.

9. Use for preventing the bursting or dehiscence of cherries, wherein the cherry cultures are treated with ABA.

10. Use according to claim 9, wherein said ABA is applied to the cherry crop(s) in combination with at least one further compound, as defined in claim 5, or as a formulation according to claim 7.

11. Method for preventing renewed burgeoning, caused by rain, of fruit trees or potato plants following a phase of dryness comprising the step of applying ABA to the fruit trees or potato plants.

12. Method according to claim 11, comprising the step of applying said ABA to the fruit trees or potato plants in combination with at least one further compound, as defined in claim 5, or as a formulation according to claim 7.

13. Use of N⁶-benzyladenine (BA) in combination with 1-naphthaleneacetic acid (NAA) for increasing the yield and quality in pomiferous fruit cultivation.

14. Use according to claim 13, wherein said use thins the fruit in apple crops.

15. A method of treating apple crops for increasing fruit yield and quality, comprising the step of applying N⁶-benzyladenine (BA) in combination with 1-naphthaleneacetic acid (NAA) to said crops to thin the fruits of the crops.

16. The method according to claim 15, wherein said BA is applied in combination with said NAA in pomiferous fruit crops, wherein said BA has an application dose of 10 to 200 g/ha and said NAA has an application dose of 1 to 50 g/ha.

17. The method according to claim 16, further comprising the step of applying said BA in combination with NAA and a wetting agent.

18. The method according to claim 15, wherein said compounds are applied when the fruits are in the stage of 8 to 14 mm.

19. A formulation for treating pomiferous fruit crops, wherein said formulation contains BA in combination with NAA.

20. The formulation according to claim 19, and further including at least one known formulation auxiliary agent selected from the group consisting of carrier materials, surfactants, solvents, and additives.

21. Use according to claim 6, wherein said ABA is used in an application dose of 0.5 to 50 g/ha.

22. Use according to claim 21, wherein said ABA is used in an application dose 0.7 to 25 g/ha.

23. Use according to claim 2, wherein said ABA is used in an application dose of 0.2 to 100 g/ha.

24. Use according to claim 23, wherein said ABA is used in an application dose of 0.5 to 50 g/ha.

25. Use according to claim 24, wherein said ABA is used in an application dose of 0.7 to 25 g/ha.

26. Use according to claim 7, wherein said additives are selected from the group consisting of ethoxylated sorbitan esters and siloxanes.

27. Use according to claim 2, wherein said compound(s) is/are used in the form of commonly used formulations containing at least one known formulation auxiliary agent selected from the group consisting of carrier materials, surfactants, solvents and additives.

28. Use according to claim 27, wherein said additives are selected from the group consisting of ethoxylated sorbitan esters and siloxanes.

29. Use according to claim 8, wherein said phytoactive amount of said compound(s) is applied to said epigeal parts of said plants.

30. Use according to claim 2, further including applying a phytoactive amount of said compound(s) to said plants, said plants having epigeal parts.

31. Use according to claim 30, wherein said phytoactive amount of said compound(s) is applied to said epigeal parts of said plants.

32. The method according to claim 16, wherein said pomiferous fruit crops are apple crops.

33. The method according to claim 16, wherein said BA is applied in combination with NAA in pomiferous fruit crops, wherein said BA has an application dose of 50 to 150 g/ha and said NAA has an application dose of 5 to 25 g/ha.

34. The method according to claim 33, wherein said BA is applied in combination with NAA in pomiferous fruit crops, wherein said BA has an application dose of 80 to 120 g/ha and said NAA has an application dose of 8 to 12 g/ha, of NAA.

35. The method according to claim 18, wherein said compounds are applied when the fruits are in the stage of 10 to 12 mm.

36. The formulation according to claim 19, wherein said BA and NAA combination further includes a wetting agent.

37. The formulation according to claim 20, wherein said additives are UV filters.
